(19) United States
(12) Patent Application Publication
(10) Pub. No.: US 2025/0272758 A1
(43) Pub. Date: Aug. 28, 2025

(54) METHOD AND SYSTEM FOR AUTOMATICALLY TRANSLATING INSURANCE RATE FILINGS INTO A PRICING ENGINE

(71) Applicant: BOLT Solutions, Inc., Austin, TX (US)

(72) Inventors: Philip Weiner, Singapore (SG); Jon Walheim, San Francisco, CA (US)

(21) Appl. No.: 19/060,058

(22) Filed: Feb. 21, 2025

Related U.S. Application Data
(60) Provisional application No. 63/557,133, filed on Feb. 23, 2024.

(51) Int. Cl. G06Q 40/08; G06F 40/205; G06F 40/58; G06Q 30/0283

(52) U.S. Cl. CPC G06Q 40/08; G06F 40/205; G06F 40/58; G06Q 30/0283

(57) ABSTRACT

Systems, methods, and computer-readable media for generating a pricing engine. The method may include monitoring, at a predetermined interval, an external system associated with an administrative body for the one or more rate filings. The method may include translating, by a natural language processing engine, the one or more rate filings, wherein the one or more rate filings are translated into a set of computer-readable data. The method may include parsing the set of computer-readable data to determine a set of pricing information. The method may include structuring, using a machine learning model trained on historical rate filing data, the set of pricing information into the pricing engine, wherein the pricing engine is operable to determine a price of insurance given a set of user data.

### CROSS REFERENCE TO RELATED APPLICATIONS

This patent application claims priority benefit, with regard to all common subject matter, of U.S. Provisional Patent Application No. 63/557,133, filed Feb. 23, 2024, and entitled “METHOD AND SYSTEM FOR AUTOMATICALLY TRANSLATING INSURANCE RATE FILINGS INTO A PRICING ENGINE.” The above-referenced application is hereby incorporated by reference in its entirety into the present application.

### BACKGROUND

### 1. Field

Embodiments of the present disclosure relate to insurance rate engines. More specifically, embodiments of the present disclosure relate to systems and methods for generating pricing engines using machine learning.

### 2. Related Art

Oftentimes, insurance providers are required to file documentation outlining their insurance rate process with various insurance regulators. For example, insurance providers may be required to file documentation with local, state, and/or federal administrative bodies. This documentation is often referred to as rate filings, where rate filings include what questions and answers affect the pricing of an insurance quote and how those questions and answers affect the pricing.

On the other side of the counter, when consumers wish to get insurance, they typically desire to “shop around” such that they have multiple quotes on the type of insurance they want to determine the best insurance option for them. Given the possible lengthy analysis that is needed by insurance providers in order to provide a quote to consumers, this may be a time-consuming process. Making things worse, many insurance providers rely on pricing methods that have yet to be digitized to provide quotes to consumers seeking insurance. This can make a slow process even slower and result in insurance providers failing to provide competitively priced quotes that are also timely.

As such, there is a need for systems and/or methods for generating pricing engines based on insurance-provider rate filings.

### SUMMARY

Embodiments of the present disclosure solve the above-mentioned problems by providing systems, methods, and computer-readable media for generating a pricing engine based on a rate filing.

In some aspects, the techniques described herein relate to one or more non-transitory computer-readable media including computer-executable instructions that, when executed by at least one processor, perform a method of generating a pricing engine based on one or more rate filings, the method including: monitoring, at a predetermined interval, an external system associated with an administrative body for the one or more rate filings; translating, by a natural language processing engine, the one or more rate filings, wherein the one or more rate filings are translated into a set of computer-readable data; parsing the set of computer-readable data to determine a set of pricing information; and structuring, using a machine learning model trained on historical rate filing data, the set of pricing information into the pricing engine, wherein the pricing engine is operable to determine a price of insurance given a set of user data.

In some aspects, the techniques described herein relate to one or more non-transitory computer-readable media, wherein the one or more rate filings are at least one of an updated version of an existing rate filing of an insurance provider or a new rate filing of the insurance provider.

In some aspects, the techniques described herein relate to one or more non-transitory computer-readable media, wherein the natural language processing engine including a large language model based on deep learning.

In some aspects, the techniques described herein relate to one or more non-transitory computer-readable media, wherein the method further includes: transmitting, by the machine learning model to the administrative body, a query for gathering information associated with structuring of the set of pricing information.

In some aspects, the techniques described herein relate to one or more non-transitory computer-readable media, wherein the query includes a request for a rate structure number in a rate filing from the one or more rate filings.

In some aspects, the techniques described herein relate to one or more non-transitory computer-readable media, wherein structuring the set of pricing information into the pricing engine includes: determining, via iteratively querying the administrative body, a field number for each rate structure in the rate filing from the one or more rate filings.

In some aspects, the techniques described herein relate to one or more non-transitory computer-readable media, wherein the method further includes: receiving, from the administrative body, an updated rate filing corresponding to an existing rate filing from the one or more rate filings; and updating the pricing engine based on the updated rate filing.

In some aspects, the techniques described herein relate to a method for generating a pricing engine based on one or more rate filings, the method including: monitoring, at a predetermined interval, a plurality of external systems associated with a plurality of administrative bodies for the one or more rate filings; translating, by a natural language processing engine, the one or more rate filings, wherein the one or more rate filings are translated into a set of computer-readable data; parsing the set of computer-readable data to determine a set of pricing information; and structuring, using a machine learning model trained on historical rate filing data, the set of pricing information into the pricing engine, wherein the pricing engine is operable to determine a price of insurance given a set of user data.

In some aspects, the techniques described herein relate to a method, further including: receiving, from a administrative body from the plurality of administrative bodies, an updated rate filing corresponding to an existing rate filing from the one or more rate filings; determining, using the machine learning model, a difference between the updated rate filing and the existing rate filing from the one or more rate filings; and updating the pricing engine based on the difference between the updated rate filing and the existing rate filing from the one or more rate filings.

In some aspects, the techniques described herein relate to a method, further including: receiving, from an administrative body from the plurality of administrative bodies, an updated rate filing corresponding to an existing rate filing from the one or more rate filings; and generating a new pricing engine based on at least the updated rate filing.

In some aspects, the techniques described herein relate to a method, wherein the one or more rate filings from the plurality of administrative bodies correspond to a singular jurisdiction such that the pricing engine determines the price of insurance for the singular jurisdiction.

In some aspects, the techniques described herein relate to a method, wherein monitoring the plurality of external systems associated with the plurality of administrative bodies for the one or more rate filings includes: scraping, via a web scraper, the one or more rate filings from the plurality of external systems.

In some aspects, the techniques described herein relate to a method, wherein the pricing engine corresponds to a plurality of insurance products.

In some aspects, the techniques described herein relate to a method, wherein the plurality of administrative bodies are at least one of federal administrative bodies or state administrative bodies.

In some aspects, the techniques described herein relate to a system for generating a quote based one rate filings, the system including: a pricing engine operable to determine a price of insurance corresponding to at least one insurance product given a set of user data; an orchestrator for parsing and structuring a set of computer-readable data into the pricing engine, wherein the orchestrator is a trained machine learning; and one or more non-transitory computer-readable media including computer-executable instructions that, when executed by at least one processor, perform a method of generating the pricing engine based on one or more rate filings, the method including: receiving, in real time, the one or more rate filings corresponding to the at least one insurance product; translating, via natural language processing, the one or more rate filings, wherein the one or more rate filings are translated into the set of computer-readable data; parsing the set of computer-readable data to determine a set of pricing information for the at least one insurance product; and structuring, via the orchestrator, the set of pricing information into the pricing engine.

In some aspects, the techniques described herein relate to a system, wherein the one or more rate filings are received in real time from at least one of an insurance provider or an administrative body.

In some aspects, the techniques described herein relate to a system, wherein the orchestrator is trained on a plurality of historical rate filings and at least one of a plurality of historical pricing engines corresponding to the plurality of historical rate filings or a plurality of quotes corresponding to the plurality of historical rate filings.

In some aspects, the techniques described herein relate to a system, wherein the pricing engine is structured with at least one of a matrix, tree, graph, list, or network.

In some aspects, the techniques described herein relate to a system, wherein the pricing engine corresponds to a singular insurance product.

In some aspects, the techniques described herein relate to a system, wherein the one or more rate filings correspond to a plurality of jurisdictions such that the pricing engine can determine the price of insurance for the plurality of jurisdictions.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 depicts an exemplary hardware system in accordance with embodiments of the invention;

FIG. 2 depicts an exemplary system for generating a pricing engine in accordance with embodiments of the invention;

FIG. 3 depicts an exemplary system for training a language model in accordance with embodiments of the invention; and

FIG. 4 depicts an exemplary flowchart for illustrating the operation of a method in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

This disclosure relates to systems, methods, and computer-readable media for generating a pricing engine. The system may include an ingestion engine. The ingestion engine may receive a rate filing from an administrative body, wherein the administrative body received the rate filing from an insurance provider. The ingestion engine may automatically scrape systems associated with the administrative body at predetermined intervals in order to obtain rate filings. The ingestion engine may provide the rate riling to a natural language processing engine. The natural language processing engine may utilize a large language model to translate the rate filing into computer-readable data. The computer-readable data may be transmitted to an orchestrator. The orchestrator may query the natural language processing engine for the computer-readable data. The orchestrator may use a machine learning model to structure the computer-readable data such that the orchestrator may output a pricing engine. The pricing engine may then be utilized by users, including persons and systems.

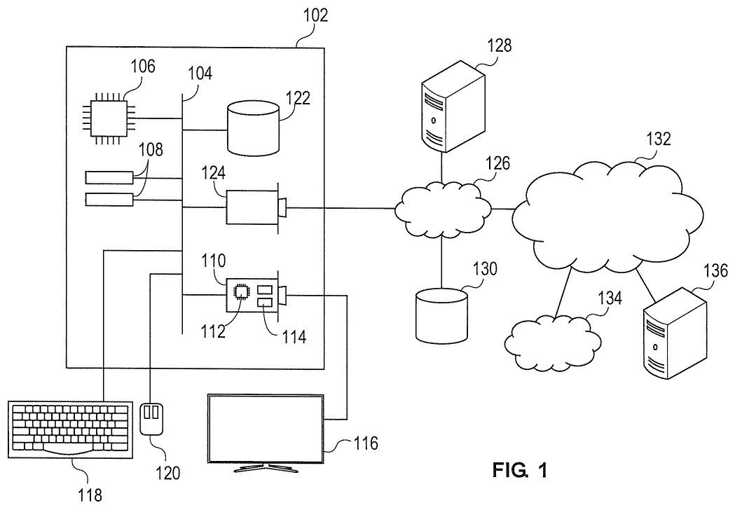

FIG. 1 depicts an exemplary hardware platform relating to some embodiments of the present disclosure. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

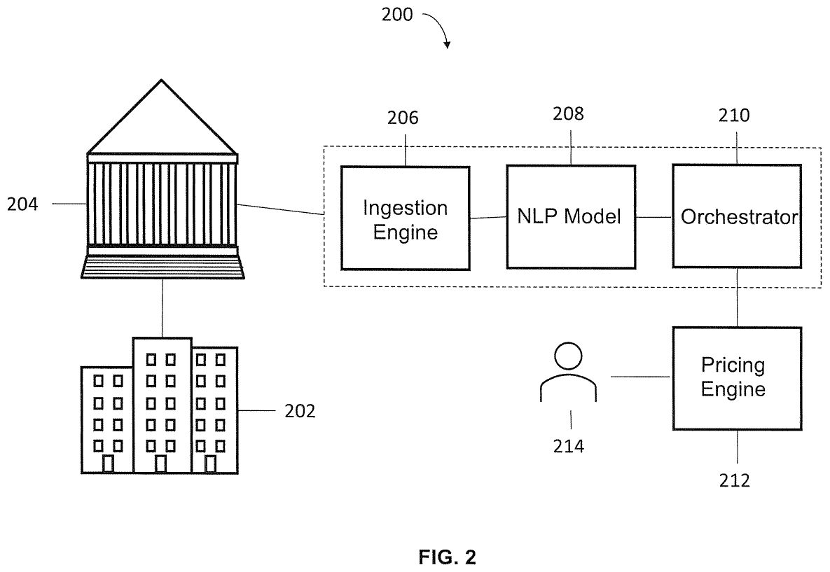

Continuing on, FIG. 2 depicts an exemplary system for generating a pricing engine in accordance with embodiments of the invention. Generally, engine generator system 200 may analyze insurance-provider rate filings in order to generate an insurance pricing engine. The pricing engine may then be used to generate an insurance quote for a particular product. Broadly, a rate filing may be a document or a collection of documents submitted to administrative body 204. The rate filing may define all the elements that are involved in pricing insurance for consumers. For example, a rate filing may include how the type of roof affects the calculation of the price of insurance to a particular customer.

In some embodiments, administrative body 204 may receive a rate filing from insurance provider 202. Generally, insurance provider 202 may be required to file various documents with any number of administrative bodies, such as administrative body 204. Administrative body 204 may be any person and/or entity who may receive rate filing documents from insurance providers, including, but not limited to, a state regulator, a federal regulator, a local regulator, and other administrative bodies. For example, administrative body 204 may be the Florida Office of Insurance Regulation. Insurance provider 202 may be any person or entity now known or later developed that provides consumers with insurance quotes, including, but not limited to, insurance companies. For example, insurance provider 202 may be a company providing a variety of health insurance products. It is noted herein that insurance provider 202 may be a provider of any type of insurance, including, but not limited to, health insurance, car insurance, life insurance, home insurance, property insurance, and other insurance types.

Broadly, ingestion engine 206 may receive rate filings from administrative body 204. In some embodiments, ingestion engine 206 may scrape a system associated with administrative body 204 for the rate filings. Put another way, ingestion engine 206 may find and detect new rate filings and/or updated rate filings by insurance provider 202. For example, ingestion engine 206 may, on a predetermined interval, interface with administrative body 204 (such as through a website) in order to gather newly filed and/or updated rate filings. In some embodiments, ingestion engine 206 may manually interface with administrative body 204 to receive the rate filings. For example, an administrator may utilize ingestion engine 206 to gather new and/or updated rate filings. In some embodiments, administrative body 204 may transmit the rate filings to ingestion engine 206. For example, administrative body 204 may automatically provide rate filings to ingestion engine 206 upon receiving them from insurance provider 202.

In some instances, it may be the case that different rate filings are filed with different administrative bodies. For example, rate filings for a particular product may differ in substance, structure, etc., depending on the jurisdiction in which they are filed. As such, in some embodiments, ingestion engine 206 may monitor multiple administrative bodies, including administrative body 204. For example, ingestion engine 206 may monitor both federal administrative bodies and the various state administrative bodies for rate filings.

After receiving the rate filing from administrative body 204, in some embodiments, ingestion engine 206 may transmit a rate filing to natural language processing model 208. Upon receiving a rate filing, natural language processing model 208 may translate the rate filing from the human-readable format and language to a computer-readable format. For example, if the rate filing is in a natural language, English format, natural language processing model 208 may translate the rate filing to a format that may be understood by a computer such that the computer can deduce the underlying meaning of the natural language.

Broadly, natural language processing model 208 may use machine learning to translate the human language of the rate filing to computer-readable language by parsing the rate filings and determining the meaning of various words, lines, sentences, structures, sections, and the like. Natural language processing model 208 may use any natural language processing technique now known or later developed, including, but not limited to, name-entity recognition, relation extraction, text summarization, topic modeling, text classification, keyword extraction, lemmatization and stemming, and similar techniques. In some embodiments, natural language processing model 208 may be a large language model. For example, natural language processing model 208 may be a large language model such that it uses a deep learning algorithm utilizing extensive data sets to recognize, summarize, translate, and predict content.

Upon translating the rate filing into a computer-readable format, natural language processing model 208 may transmit the computer-readable data to orchestrator 210. Upon receiving the computer-readable data corresponding to the rate filing, orchestrator 210 may structure the computer-readable data to create pricing engine 212. For example, orchestrator 210 may take unstructured data relating to zip codes and structure the data such that a system may determine the effect of a zip code on a user's insurance price.

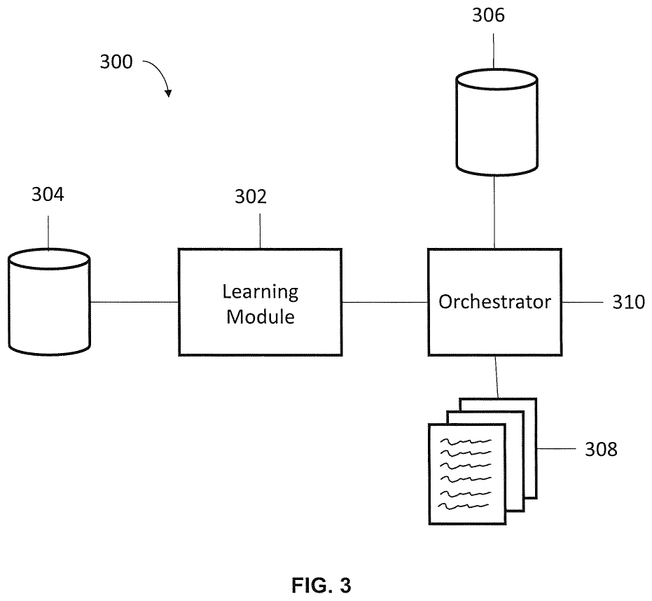

In some embodiments, orchestrator 210 may utilize machine learning to understand how to structure information received from natural language processing model 208 such that it may be used to price insurance given a set of specific facts. As described below with respect to orchestrator 310, depicted in FIG. 3, orchestrator 210 may be trained using any suitable training data sets, including, but not limited to, historical rate filings and the corresponding pricing engines. The use of machine learning by orchestrator 210 is described further below as it relates to orchestrator 310 depicted in FIG. 3.

In some embodiments, orchestrator 210 may query natural language processing model 208 for pricing information. Generally, the queries may serve the purpose of allowing the orchestrator 210 to gather information for structuring the unstructured, translated data provided by natural language processing model 208. For example, orchestrator 210 may query natural language processing model 208 and ask for the number of rate structures included in the rating filing. Accordingly, upon learning how many rate structures are in the rate filing, orchestrator 210 may query natural language processing model 208 and ask for the number of fields included in a first rate structure. This may continue until orchestrator 210 has the information to generate a pricing engine.

In some instances, insurance provider 202 may update the way in which they calculate a rate for a given product. As such, insurance provider 202 may refile a rate document with administrative body 204. Therefore, in some embodiments, orchestrator 210 may update a pre-existing pricing engine as opposed to generating a new pricing engine. In such embodiments, orchestrator 210 may utilize machine learning and/or any other method to determine the difference between a new rate filing and an older rate filing and/or the pre-existing pricing engine in order to determine what changes must be made to the pricing engine.

In some embodiments, as described above, orchestrator 210 may output pricing engine 212. Pricing engine 212 may correspond to a single product or any number of products. Pricing engine 212 may be in any form now known or later developed, including, but not limited to, a matrix, a series of matrices, a table, a series of tables, a data structure, any number of data structures, and the like. In some embodiments, pricing engine 212 may be tailored to rate filings from a specific jurisdiction, for example, the state of Florida. In other embodiments, pricing engine 212 may be utilized for rate filings from a plurality of jurisdictions.

In some embodiments, pricing engine 212 may be utilized by user 214. User 214 may interface with pricing engine 212 in order to receive a quote from insurance for themselves and/or on behalf of another person. In some embodiments, user 214 may be a system and/or entity. For example, user 214 may be system configured to interface with any number of pricing engines (including user 214) in order to receive a plurality of insurance quotes corresponding to a plurality of products. As a result, user 214 may be able to provide consumers with a variety of insurance quotes in an efficient manner.

Continuing on, FIG. 3 depicts an exemplary system for training a language model in accordance with embodiments of the invention. Broadly, system 300 may train orchestrator 310, generally corresponding to orchestrator 210 of FIG. 2. It is noted herein that natural language processing model 208 (described above) and orchestrator 310 may be trained using the same system or a different system. While FIG. 3 depicts orchestrator 310, system 300 is not limited to orchestrator 310 and instead may extend to other systems utilizing machine learning, including, but not limited to, natural language processing model 208 depicted in FIG. 2.

In some embodiments, learning module 302 may train orchestrator 310. In some embodiments, learning module 302 may receive training data from training data store 304. The training data may be any suitable information now known or later developed for informing orchestrator 310. For example, the training data may include, but is not limited to, actuarial memorandums, underwriting guidelines, underwriting questionnaires, policy forms, historical rate filings and their corresponding pricing engines, insurance-related documents, and the like.

Orchestrator 310 may be any type of machine-learning model now known or later developed, such as a supervised machine-learning system, an unsupervised machine-learning system, a rule-based system, a dictionary-based system, a bootstrapping system, a neural network system, a statistical system, a semantic role labeling system, a large language model, a generative machine learning system, a tuning of a large language model, a series of prompts to a large language model, a combination of the above-mentioned systems, and the like. In some embodiments, orchestrator 310 may be trained using learning module 302. Learning module 302 may receive training data from training data store 304. Broadly, training data store 304 may be any data store now known or later developed, including but not limited to an internal data store, an external data store, a cloud-based data store, a singular data store, a plurality of data stores, and the like.

Generally, the training data stored in training data store 304 and used by learning module 302 to train orchestrator 310 may be any suitable data set. In some embodiments, learning module 302 may utilize past rate filings and their corresponding pricing engines, insurance quotes and their corresponding facts, and the like. For example, learning module 302 may utilize past insurance quotes and their corresponding facts issued by insurance providers in order to train orchestrator 310 to determine the relationship between various fields in an unstructured rate filing document.

Further, in some embodiments, orchestrator 310 may parse and understand written human language (or interface with an additional machine learning model that parses and understands written human language, such as natural language processing model 208 depicted in FIG. 2) in order to determine what a given question is asking. As such, learning module 302 may use natural language processing model to train orchestrator 310. Orchestrator 310 may be trained using any natural language processing technique now known or later developed, including, but not limited to, name-entity recognition, relation extraction, text summarization, topic modeling, text classification, keyword extraction, lemmatization and stemming, and similar techniques. For example, learning module 302 may parse rate filings (using, for example, natural language processing or a large language model) to identify the information being discussed.

Upon being trained, the orchestrator may receive rate filing data housed in data store 306, such as that which may be received by insurance provider 202, depicted in FIG. 2. In some embodiments, the rate filing data received may be live data such that it is received in real-time from insurance providers and/or administrative bodies, such as insurance provider 202 and administrative body 204, depicted in FIG. 2. As described above with regard to FIG. 2, orchestrator 310 may receive a plurality of rate filings.

After receiving one or more inputs, in some embodiments, orchestrator 310 may output pricing engine 308, the pricing engine 308 corresponding to particular products that are the subject of rate filings received from training data store 304. As described above, pricing engine 308 may provide the price of an insurance product for a given set of facts. For example, if a user inputs the facts pertaining to their specific insurance situation, pricing engine 308 may output the price and/or quote associated with the user's situation.

In some embodiments, pricing engine 308 may be verified. For example, pricing engine 308 may be verified by comparing an output of pricing engine 308 with an output obtained directly from the insurance provider in which the product associated with pricing engine 308 relates. In such embodiments, pricing engine 308 may be escalated to an administrative review if it is determined that the accuracy of pricing engine 308 falls below a predetermined threshold.

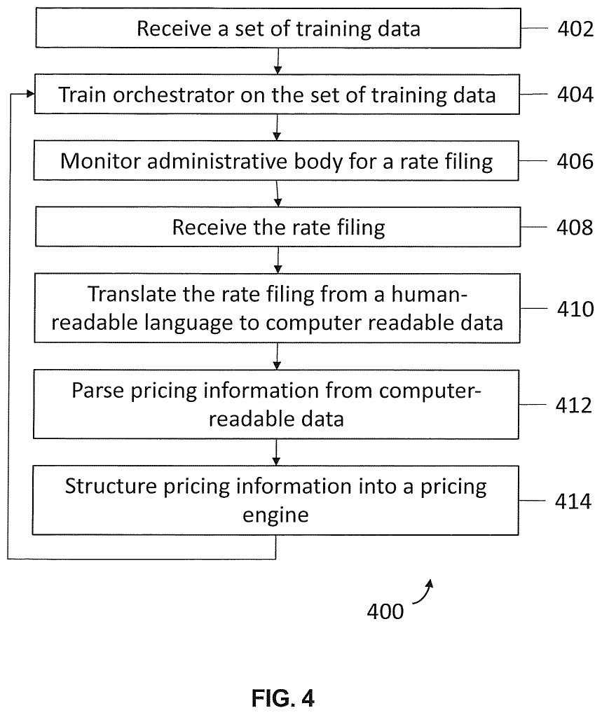

Finally, FIG. 4 depicts an exemplary flowchart for illustrating the operation of a method in accordance with embodiments of the invention. Method 400 relates to generating a pricing engine from a rate filing using a machine-learning informed orchestrator. In step 402, a set of training data is received. As described above with respect to FIG. 3, the set of training data may include any suitable data, including, but not limited to, insurance pricing information, historical insurance quotes, insurance tables, historical rate filings, and the like. For example, the training data may include historical rate filings and their corresponding digital pricing engines for any number of products by any number of insurance providers.

In step 404, an orchestrator is trained using the training data set. At a high level, the orchestrator may be trained using a learning module, such as learning module 302, depicted in FIG. 3. The orchestrator may be trained using any technique now known or later developed, including, but not limited to, supervised learning and unsupervised learning. In some embodiments, as described above with respect to orchestrator 210 and orchestrator 310 of FIGS. 2 and 3, respectively, an orchestrator may be trained to structure pricing information such that it may be used to provide a quote given a predetermined set of inputs.

In step 406, an administrative body is monitored for a rate filing. In some embodiments, as described above with respect to ingestion engine 206, a system may automatically scrape a system associated with an administrative body, such as a data store, website, server, etc., in order to obtain rate filings. In such embodiments, the administrative body may be scraped by a system at predetermined intervals, such as every twenty-four hours, every hour, every week, and the like. Any number of administrative bodies may be scraped to obtain rate filings, including, but not limited to, federal and state administrative bodies.

In step 408, a rate filing is received. Generally, the rate filing may include information regarding the calculation of an insurance rate. The rate filing may be in human-readable language, and it may be unstructured. As discussed above with respect to step 406, a rate filing may be received via a system scrape, such as using a scraper on the website associated with an administrative body. In some embodiments, a rate filing may be received via an administrator. For example, an administrator of the system may interface with a system associated with an administrative body in order to obtain rate filings. In some embodiments, rate filings are received automatically from an administrative body. For example, the administrative body may transmit the rate filing to the system.

In step 410, the rate filing is translated. In some embodiments, the rate filing may be translated from a human-readable language to computer-readable data. As described above with respect to natural language processing model 208 depicted in FIG. 2, the computer-readable data may be translated using machine learning. For example, the rate filing may be translated from a human-readable language to computer-readable data using a large language model.

In step 412, pricing information is parsed from the computer-readable data. In some embodiments, an orchestrator may query a natural language processing engine to receive pricing information. For example, the pricing information may be parsed to determine all the various fields needed in order to provide an insurance quote, including questions and answers and the impact said questions and answers may have on the price of insurance. For example, the pricing information may be parsed to determine how roof shape affects pricing and what questions need to be asked with regard to roof shape in order to determine the proper pricing of insurance.

In step 414, the pricing information is structured into a pricing engine. In some embodiments, the pricing information may be structured by the orchestrator. The pricing information may be structured into any format now known or later developed that may show the relationship between questions, answers, fields, etc., including, but not limited to, matrices, graphs, trees, lists, networks, and similar data structures. The pricing engine may then be used by users and/or systems in order to generate quotes for given sets of facts.

Although the present disclosure has been described with reference to the embodiments illustrated in the attached drawing figures, it is noted that equivalents may be employed and substitutions made herein without departing from the scope of the present disclosure as recited in the claims.

Features described above as well as those claimed below may be combined in various ways without departing from the scope hereof. The following examples illustrate some possible, non-limiting combinations:

Clause 1. One or more non-transitory computer-readable media comprising computer-executable instructions that, when executed by at least one processor, perform a method of generating a pricing engine based on one or more rate filings, the method comprising: monitoring, at a predetermined interval, an external system associated with an administrative body for the one or more rate filings; translating, by a natural language processing engine, the one or more rate filings, wherein the one or more rate filings are translated into a set of computer-readable data; parsing the set of computer-readable data to determine a set of pricing information; and structuring, using a machine learning model trained on historical rate filing data, the set of pricing information into the pricing engine, wherein the pricing engine is operable to determine a price of insurance given a set of user data.

Clause 2. The one or more non-transitory computer-readable media of clause 1, wherein the one or more rate filings are at least one of an updated version of an existing rate filing of an insurance provider or a new rate filing of the insurance provider.

Clause 3. The one or more non-transitory computer-readable media of clause 1 or clause 2, wherein the natural language processing engine comprising a large language model based on deep learning.

Clause 4. The one or more non-transitory computer-readable media of clause 1 through clause 3, wherein the method further comprises: transmitting, by the machine learning model to the administrative body, a query for gathering information associated with structuring of the set of pricing information.

Clause 5. The one or more non-transitory computer-readable media of clause 1 through clause 4, wherein the query includes a request for a rate structure number in a rate filing from the one or more rate filings.

Clause 6. The one or more non-transitory computer-readable media of clause 1 through clause 5, wherein structuring the set of pricing information into the pricing engine comprises: determining, via iteratively querying the administrative body, a field number for each rate structure in the rate filing from the one or more rate filings.

Clause 7. The one or more non-transitory computer-readable media of clause 1 through clause 6, wherein the method further comprises: receiving, from the administrative body, an updated rate filing corresponding to an existing rate filing from the one or more rate filings; and updating the pricing engine based on the updated rate filing.

Clause 8. A method for generating a pricing engine based on one or more rate filings, the method comprising: monitoring, at a predetermined interval, a plurality of external systems associated with a plurality of administrative bodies for the one or more rate filings; translating, by a natural language processing engine, the one or more rate filings, wherein the one or more rate filings are translated into a set of computer-readable data; parsing the set of computer-readable data to determine a set of pricing information; and structuring, using a machine learning model trained on historical rate filing data, the set of pricing information into the pricing engine, wherein the pricing engine is operable to determine a price of insurance given a set of user data.

Clause 9. The method of clause 8, further comprising: receiving, from a administrative body from the plurality of administrative bodies, an updated rate filing corresponding to an existing rate filing from the one or more rate filings; determining, using the machine learning model, a difference between the updated rate filing and the existing rate filing from the one or more rate filings; and updating the pricing engine based on the difference between the updated rate filing and the existing rate filing from the one or more rate filings.

Clause 10. The method of clause 8 or clause 9, further comprising: receiving, from an administrative body from the plurality of administrative bodies, an updated rate filing corresponding to an existing rate filing from the one or more rate filings; and generating a new pricing engine based on at least the updated rate filing.

Clause 11. The method of clause 8 through clause 10, wherein the one or more rate filings from the plurality of administrative bodies correspond to a singular jurisdiction such that the pricing engine determines the price of insurance for the singular jurisdiction.

Clause 12. The method of clause 8 through clause 11, wherein monitoring the plurality of external systems associated with the plurality of administrative bodies for the one or more rate filings comprises: scraping, via a web scraper, the one or more rate filings from the plurality of external systems.

Clause 13. The method of clause 8 through clause 12, wherein the pricing engine corresponds to a plurality of insurance products.

Clause 14. The method of clause 8 through clause 13, wherein the plurality of administrative bodies are at least one of federal administrative bodies or state administrative bodies.

Clause 15. A system for generating a quote based one rate filings, the system comprising: a pricing engine operable to determine a price of insurance corresponding to at least one insurance product given a set of user data; an orchestrator for parsing and structuring a set of computer-readable data into the pricing engine, wherein the orchestrator is a trained machine learning; and one or more non-transitory computer-readable media comprising computer-executable instructions that, when executed by at least one processor, perform a method of generating the pricing engine based on one or more rate filings, the method comprising: receiving, in real time, the one or more rate filings corresponding to the at least one insurance product; translating, via natural language processing, the one or more rate filings, wherein the one or more rate filings are translated into the set of computer-readable data; parsing the set of computer-readable data to determine a set of pricing information for the at least one insurance product; and structuring, via the orchestrator, the set of pricing information into the pricing engine.

Clause 16. The system of clause 15, wherein the one or more rate filings are received in real time from at least one of an insurance provider or an administrative body.

Clause 17. The system of clause 15 or clause 16, wherein the orchestrator is trained on a plurality of historical rate filings and at least one of a plurality of historical pricing engines corresponding to the plurality of historical rate filings or a plurality of quotes corresponding to the plurality of historical rate filings.

Clause 18. The system of clause 15 through clause 17, wherein the pricing engine is structured with at least one of a matrix, tree, graph, list, or network.

Clause 19. The system of clause 15 through clause 18, wherein the pricing engine corresponds to a singular insurance product.

Clause 20. The system of clause 15 through clause 19, wherein the one or more rate filings correspond to a plurality of jurisdictions such that the pricing engine can determine the price of insurance for the plurality of jurisdictions.

Having thus described various embodiments of the present disclosure, what is claimed as new and desired to be protected by Letters Patent includes the following:

1. One or more non-transitory computer-readable media comprising computer-executable instructions that, when executed by at least one processor, perform a method of generating a pricing engine based on one or more rate filings, the method comprising:
monitoring, at a predetermined interval, an external system associated with an administrative body for the one or more rate filings;
translating, by a natural language processing engine, the one or more rate filings, wherein the one or more rate filings are translated into a set of computer-readable data;
parsing the set of computer-readable data to determine a set of pricing information; and
structuring, using a machine learning model trained on historical rate filing data, the set of pricing information into the pricing engine,
wherein the pricing engine is operable to determine a price of insurance given a set of user data.

2. The one or more non-transitory computer-readable media of claim 1,
wherein the one or more rate filings are at least one of an updated version of an existing rate filing of an insurance provider or a new rate filing of the insurance provider.

3. The one or more non-transitory computer-readable media of claim 1,
wherein the natural language processing engine comprising a large language model based on deep learning.

4. The one or more non-transitory computer-readable media of claim 1,
wherein the method further comprises:
transmitting, by the machine learning model to the administrative body, a query for gathering information associated with structuring of the set of pricing information.

5. The one or more non-transitory computer-readable media of claim 4,
wherein the query includes a request for a rate structure number in a rate filing from the one or more rate filings.

6. The one or more non-transitory computer-readable media of claim 5,
wherein structuring the set of pricing information into the pricing engine comprises:
determining, via iteratively querying the administrative body, a field number for each rate structure in the rate filing from the one or more rate filings.

7. The one or more non-transitory computer-readable media of claim 1,
wherein the method further comprises:
receiving, from the administrative body, an updated rate filing corresponding to an existing rate filing from the one or more rate filings; and
updating the pricing engine based on the updated rate filing.

8. A method for generating a pricing engine based on one or more rate filings, the method comprising:
monitoring, at a predetermined interval, a plurality of external systems associated with a plurality of administrative bodies for the one or more rate filings;
translating, by a natural language processing engine, the one or more rate filings, wherein the one or more rate filings are translated into a set of computer-readable data;
parsing the set of computer-readable data to determine a set of pricing information; and
structuring, using a machine learning model trained on historical rate filing data, the set of pricing information into the pricing engine,
wherein the pricing engine is operable to determine a price of insurance given a set of user data.

9. The method of claim 8, further comprising:
receiving, from a administrative body from the plurality of administrative bodies, an updated rate filing corresponding to an existing rate filing from the one or more rate filings;
determining, using the machine learning model, a difference between the updated rate filing and the existing rate filing from the one or more rate filings; and
updating the pricing engine based on the difference between the updated rate filing and the existing rate filing from the one or more rate filings.

10. The method of claim 8, further comprising:
receiving, from an administrative body from the plurality of administrative bodies, an updated rate filing corresponding to an existing rate filing from the one or more rate filings; and
generating a new pricing engine based on at least the updated rate filing.

11. The method of claim 8,
wherein the one or more rate filings from the plurality of administrative bodies correspond to a singular jurisdiction such that the pricing engine determines the price of insurance for the singular jurisdiction.

12. The method of claim 8,
wherein monitoring the plurality of external systems associated with the plurality of administrative bodies for the one or more rate filings comprises:
scraping, via a web scraper, the one or more rate filings from the plurality of external systems.

13. The method of claim 8,
wherein the pricing engine corresponds to a plurality of insurance products.

14. The method of claim 8,
wherein the plurality of administrative bodies are at least one of federal administrative bodies or state administrative bodies.

15. A system for generating a quote based one rate filings, the system comprising:
a pricing engine operable to determine a price of insurance corresponding to at least one insurance product given a set of user data;
an orchestrator for parsing and structuring a set of computer-readable data into the pricing engine, wherein the orchestrator is a trained machine learning; and
one or more non-transitory computer-readable media comprising computer-executable instructions that, when executed by at least one processor, perform a method of generating the pricing engine based on one or more rate filings, the method comprising:
receiving, in real time, the one or more rate filings corresponding to the at least one insurance product;
translating, via natural language processing, the one or more rate filings, wherein the one or more rate filings are translated into the set of computer-readable data;
parsing the set of computer-readable data to determine a set of pricing information for the at least one insurance product; and
structuring, via the orchestrator, the set of pricing information into the pricing engine.

16. The system of claim 15,
wherein the one or more rate filings are received in real time from at least one of an insurance provider or an administrative body.

17. The system of claim 15,
wherein the orchestrator is trained on a plurality of historical rate filings and at least one of a plurality of historical pricing engines corresponding to the plurality of historical rate filings or a plurality of quotes corresponding to the plurality of historical rate filings.

18. The system of claim 15,
wherein the pricing engine is structured with at least one of a matrix, tree, graph, list, or network.

19. The system of claim 15,
wherein the pricing engine corresponds to a singular insurance product.

20. The system of claim 15,
wherein the one or more rate filings correspond to a plurality of jurisdictions such that the pricing engine can determine the price of insurance for the plurality of jurisdictions.
